(19) United States
(12) Patent Application Publication
(10) Pub. No.: US 2013/0117005 A1
(43) Pub. Date: May 9, 2013

(54) COVERAGE ANALYSIS FOR MULTIPLE TEST METHODOLOGIES

(71) Applicants: Eitan Farchi, Pardes Hana (IL); Howard M. Hess, Winnetka, IL (US); Onn M. Shehory, Yahud-Monosson (IL); Aviad Zlotnick, Mitzpeh Netofah (IL)

(72) Inventors: Eitan Farchi, Pardes Hana (IL); Howard M. Hess, Winnetka, IL (US); Onn M. Shehory, Yahud-Monosson (IL); Aviad Zlotnick, Mitzpeh Netofah (IL)

(73) Assignee: International Business Machines Corporation, Armonk, NY (US)

(21) Appl. No.: 13/291,115

(22) Filed: Nov. 8, 2011

(51) Int. Cl. G06F 9/44

(52) U.S. Cl. 703/21

(57) ABSTRACT

Systems and methods for constructing a model to test the functionality of a target system are provided. When a first test methodology is used to test the target system, a model is proposed to test the target system based on a second test methodology. A subset of the target system's properties covered by the model is selected according to the second test methodology. It is determined whether the selected subset of the target system's properties, as covered by the second test methodology, is covered by the first test methodology.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to testing computing systems and, more particularly, to evaluating the level of coverage by different test methodologies.

### BACKGROUND

Many organizations and entities rely on some form of testing methodology to evaluate the proper functionality of their systems and computing environments. Depending on the level of investment and tenure associated with a test suite, an organization may resent upgrading the test suite, unless an analysis can be performed to quantitatively prove the added value and benefits of such upgrade.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, systems and methods for constructing a model to test the functionality of a target system are provided. When a first test methodology is used to test the target system, a model is proposed to test the target system based on a second test methodology. A subset of the target system's properties covered by the model is selected according to the second test methodology. It is determined whether the selected subset of the target system's properties as covered by the second test methodology is covered by the first test methodology.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 illustrates an exemplary environment in accordance with one or more embodiments, wherein a coverage model is used to test a target system.

FIG. 2 is a flow diagram of an exemplary method for evaluating the differences between two or more test methodologies, in accordance with one embodiment.

FIGS. 3A and 3B are block diagrams of hardware and software environments in which the disclosed systems and methods may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

In one embodiment, to evaluate the advantages of applying a test methodology (hereafter the “proposed test methodology”) to a target system, a coverage model for the target system is constructed. A test suite (hereafter the “proposed test suite”) is then generated for the model so that the functionality of the target system may be tested according to the proposed test methodology. As provided in further detail below, the proposed test suite may desirably cover certain properties of the target system (e.g., attributes and values assigned to those attributes), according to a designated interaction level between those attributes, for example.

Based on the results expected from executing the tests in the proposed test suite, the level of coverage of the model may be determined. The coverage results may then be compared with the level of coverage provided by an existing test suite for the target system. In some scenarios, the target system may not be directly accessible, or the mapping between the existing test suite and the model constructed for the target system may be hard to implement.

For example, the target system may be under the control of a third party, remotely located with respect to the location of the model, behind a mechanism that would not grant authority to access the target system, or the test suite may be represented without an explicit mention of the model components. In such scenarios, the test coverage comparison may be based on the results of a survey completed by a party that has access to the target system or a detailed knowledge of the existing test suite.

It is noteworthy that in some scenarios, it is possible to compute the expected coverage of the proposed test suite without computing or executing the test in a proposed test suite. For example, an algorithm may be utilized to construct a test suite with approximately 100% coverage as generated from the proposed model. Combinatorial algorithms, and the related test design models that are implemented based on random testing, are examples of such algorithms that may be utilized, in one or more embodiments.

In one exemplary implementation, the survey results are analyzed to determine the current level of coverage afforded by the existing test suite. By comparing the level of coverage associated with the existing test suite with the level of coverage provided by the proposed test suite, the benefits and advantages of the proposed test suite may be determined. Ultimately, the comparison results may be used to determine whether to utilize the proposed test suite instead or in combination with the existing test suite.

For example, the test results may be provided to a human operator (e.g., a system administrator, or other decision maker) to help determine whether the proposed test suite and the related test methodology should be implemented as a replacement or in complement to the existing test suite for the target system. In another example, the test results may be provided to a machine (e.g., an automated system) that is able to update or replace the existing test suite for the target system based on the proposed test suite or a proposed test methodology.

The result of the comparison between the two test suites may include metrics related to the difference between the number of bugs detected, the efficiency of the testing mechanisms, and the overall level of coverage for certain variable combinations or other system variables or properties of interest. Using the test results, one may be also able to estimate in a meaningful manner the improvements or the added degree of efficiency that application of the proposed test suite or methodology will have on the functionality of the target system.

In accordance with one or more embodiments, the coverage model proposed to test the target system defines variables, possible values for the variables, and conditions or restrictions indicating when values for one or more variables or value combinations for a plurality of variables are valid or invalid. The set of valid value combinations and requirements for combinations of variables that are to be included in the test scope define the level of coverage. The size of the test scope, in one example, may be defined by the product (e.g., the Cartesian product) of variable values, taking into account the dictated conditions and restrictions.

It is noteworthy that the size of a Cartesian product based model is the product of the number of values for each attribute (i.e., A₁*A₂* . . . *Aₙ), where Aₙ represents the number of valid values for the n^{th} attribute. One would appreciate that the size of the model can become prohibitively large, depending on the number of attributes, the possible number of values assigned to each attribute and the restrictions. The size of the test space defined by the Cartesian product based model may be larger than a certain threshold.

If the above scenario is true, in one embodiment, subsets of the variables whose combinations are to be covered are defined. For example, when the Cartesian product of every two variables is covered, the resulting test scope is noticeably smaller than the full Cartesian product, yet the ability to detect bugs may be slightly less successful than the full product. The subsets of the variables whose combinations are covered, based on a designation interaction level, are referred to as the required interactions, or interaction requirements.

A combinatorial algorithm may be applied to the set of tests in the proposed test suite to further narrow the test space, so that a smaller number of tests are performed on the coverage model. For example, the restrictions for the combination of variable values may be provided as input to a combinatorial test design (CTD) engine. Given a Cartesian product model with n variables, a combinatorial algorithm may be used to find a subset of valid variable value combinations in the test space that covers possible combinations of every m variables, wherein m defines the interaction level.

The interaction level, depending on implementation, refers to the coverage of the selected subset of the test space, wherein the test space covers the possible combinations of m number of variables in the set defined by the respective coverage model—m is less than or equal to the total number of variables n in the model. As hinted earlier, the motivation for this approach is that empiric evidence show that most bugs depend on the interaction between a small number of variables. In general, testing such interactions leads to detecting a majority of bugs in a system.

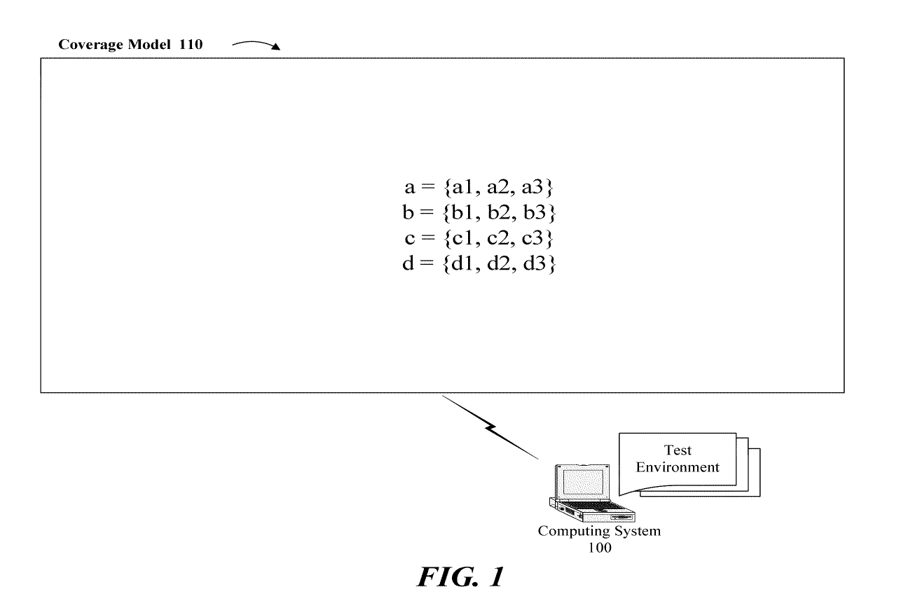

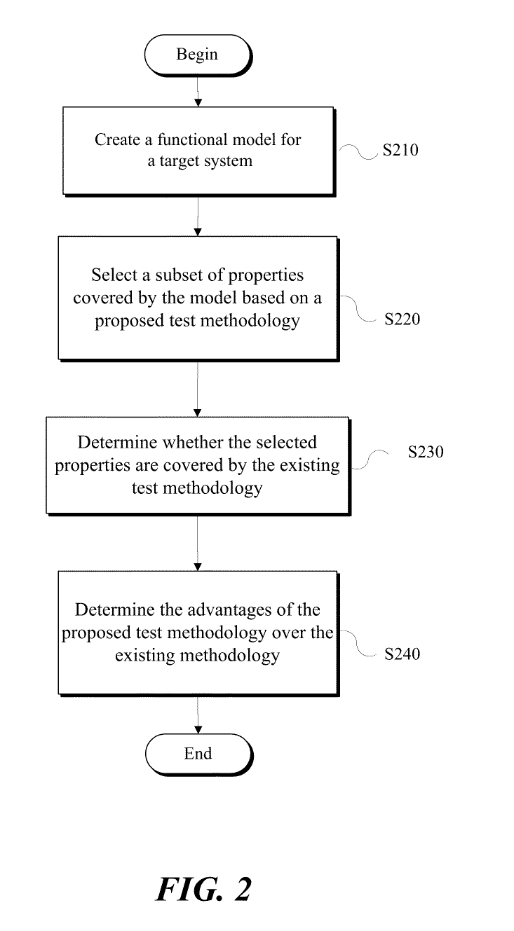

Referring to FIGS. 1 and 2, a coverage model 110 may be constructed over computing system 100 to test the functionality of a target system (not shown) (S210). A proposed test suite may provided based on (1) a set of variables and the possible variable values, (2) conditions that define restrictions on said values or combinations of values that may be assigned to those variables, and (3) a set of defined conditions for combinations of variables that are to be included in the proposed test suite.

In an optional embodiment, it may be desirable to exclusively use the set of legal combinations generated from the model to evaluate the existing test suite. Never-the-less, the proposed test suite may be implemented to test the test space defined by the coverage model 110 according to a proposed test methodology. In an example scenario involving four variables, the following presentation of possible values may be provided for variables a, b, c and d:
a={a1, a2, a3}
b={b1, b2, b3}
c={c1, c2, c3}
d={d1, d2, d3}

As noted earlier, the proposed test suite may cover a number of variable value combinations to test the target system. As such, coverage model 110 may cover a plurality of properties for the target system depending on the proposed test methodology. In one embodiment, based on the proposed test methodology, a subset of the system properties covered by model 110 is selected (S220). It is then determined, by way of an analysis, whether the selected properties covered by the proposed test methodology are also covered by the existing test methodology, or other competing test methodology, utilized to test the target system (S230). The result of the analysis is then used to determine the advantages of the proposed test terminology over the existing test terminology (S240).

In scenarios with limited access to the target system, where a survey strategy is used for example, the exact level of coverage by an existing test suite may not be determinable, because the party responding to the survey may not know the answers to all the questions asked in the survey. As such, in one embodiment, the difference between the scope of coverage associated with the proposed test methodology and the existing test methodology may be estimated by assigning a first weight to the answers that provide a definitive response to a question, and assigning a second weight to answers that do not.

In one implementation, optionally, the number of answers that are non-responsive or reflect the inability of the responder to provide a meaningful response may be counted. If the result indicates that the number of answers that fall in the above category is above a certain threshold, then that may be an indication that the proposed methodology has an advantage over the existing one.

The opportunity for improving test coverage for the target system may be estimated based on the difference between 100% coverage of a functional model based on a combinatorial test design (CTD) and the estimated test coverage calculated using the methods disclosed above. With additional information, a benefit analysis based on advantages of using the proposed test methodology may be expanded to also include estimated benefits that result from finding more defects or bugs in the target system during testing, with a corresponding reduction in defects in production (e.g., defect escapes).

Data collected about previous defects that escaped discovery during testing and reached production, using the existing test methodology, may be utilized to estimate the benefits of the proposed test methodology over the existing one. For example, if the coverage P based on the existing test methodology yielded N escapes, then the additional coverage (1-P) provided by proposed test methodology should prevent approximately N*(1-P) of the escapes. For example, if the coverage P based on the existing test suite was 0.7, and there were 100 escapes, and the coverage was increased by 0.3 using the proposed test suite, then at least 30 of the 100 escapes should be prevented, due to the use of the proposed test methodology.

Other calculations may also be utilized to determine the advantages of the proposed test methodology over a competing one. For example, information about bugs found in tests and about the rate of finding bugs per test applied may be deduced from the results collected from the application of the above procedures. In one example, given information about the cost of test escapes and the expected savings from the proposed coverage improvement may be calculated. The calculation based on test escapes may be pro-rated for (1) relative size/complexity of the changes in different versions or releases of the target system and (2) changes in the size of the test suite from one release to the next.

In one embodiment, the quality of responses provided in a third party survey may be quantified by randomly asking the third party to provide evidence that a system property (e.g., a variable value or a variable value combination) for the target system is covered by the existing test methodology. The accuracy of the third party responses may be determined accordingly. In one embodiment, additional information such as coverage holes for interesting variables or interesting variable value combinations may also be determined based on the result obtained from the above noted analysis. In one embodiment, several iterations on such surveys may be used to increase accuracy.

Depending on implementation, the model constructed for the target system may be industry specific. That is, the model may be designed based on attributes, variable, parameters or values common to a certain industry or line of work. For example, if the target system is used in a bank, then the model will be designed accordingly, or if available, a model that has been customized for financial transaction may be used as a skeleton or primary data structure to construct the model for the bank's system.

References in this specification to “an embodiment”, “one embodiment”, “one or more embodiments” or the like, mean that the particular element, feature, structure or characteristic being described is included in at least one embodiment of the disclosed subject matter. Occurrences of such phrases in this specification should not be particularly construed as referring to the same embodiment, nor should such phrases be interpreted as referring to embodiments that are mutually exclusive with respect to the discussed features or elements.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

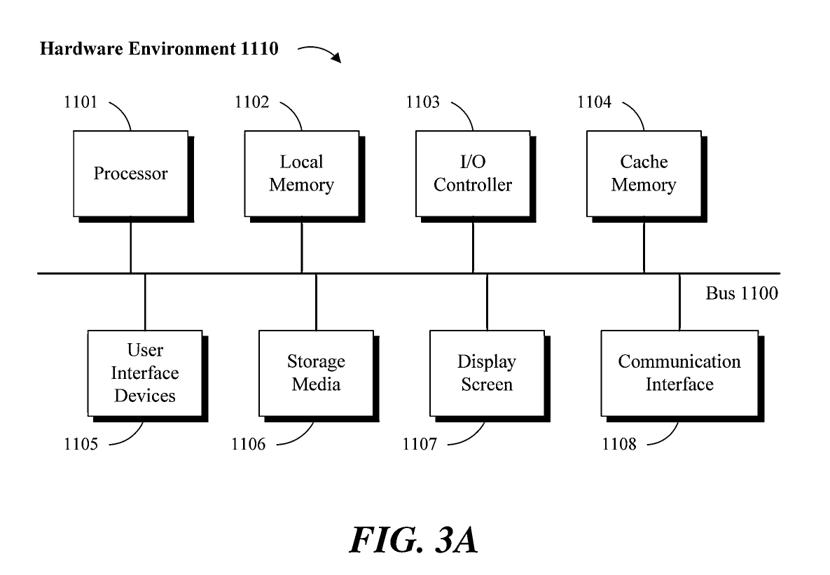

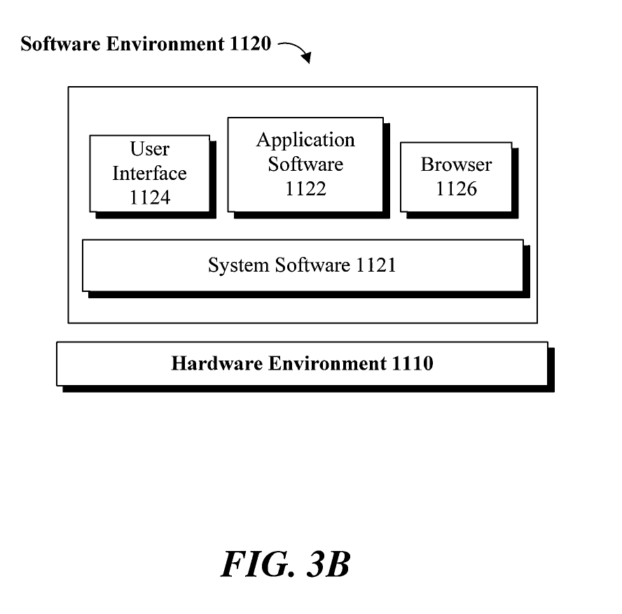

Referring to FIGS. 3A and 3B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 3A, the application software and logic code disclosed herein may be implemented in the form of machine readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other machine-usable or computer readable media. Within the context of this disclosure, a machine usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-RAY), digital video disk (DVD), high definition video disk (HD-DVD) or Blue-ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a machine such as a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 3B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a machine-usable or computer readable storage medium that provides program code for use by, or in connection with, a machine, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, can be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A method for execution on a machine, the method comprising:
constructing a model to test the functionality of a target system, wherein a first test methodology has been used to test the target system, and the model is proposed to test the target system based on a second test methodology;
selecting a subset of the target system's properties covered by the model according to the second test methodology; and
determining whether the selected subset of the target system's properties as covered by the second test methodology is covered by the first test methodology.

2. The method of claim 1 further comprising determining advantages of the second test methodology over the first test methodology.

3. The method of claim 1, wherein a survey mechanism is utilized to determine whether the selected subset of the target system's properties is covered by the first test methodology.

4. The method of claim 2, wherein the first test methodology is updated based on the second test methodology, in response to determining the advantages of the second test methodology.

5. The method of claim 2, wherein the first test methodology is replaced with the second test methodology, in response to determining the advantages of the second test methodology.

6. The method of claim 2 further comprising providing a report that indicates associated improvements in test coverage for the target system based on the determined advantages associated with the second test terminology.

7. The method of claim 1 wherein the second test methodology employs a combinatorial algorithm to implement a proposed test suite for the model, wherein the proposed test suite includes a smaller number of tests than the test suite implemented based on the first test methodology.

8. The method of claim 7 wherein the combinatorial algorithm is used to select tests with interesting variable value combinations for the model.

9. The method of claim 1 wherein the model is constructed according to attributes that are specific to industry in which the target system is utilized.

10. The method of claim 3 wherein survey results is monitored to determine number of answers that do not provide a meaningful response to a corresponding survey question to determine advantages of the second test methodology over the first test methodology.

11. A system comprising:
one or more processors;
a logic unit for constructing a model to test the functionality of a target system, wherein a first test methodology has been used to test the target system, and the model is proposed to test the target system based on a second test methodology;
a logic unit for selecting a subset of the target system's properties covered by the model according to the second test methodology; and
a logic unit for determining whether the selected subset of the target system's properties as covered by the second test methodology is covered by the first test methodology.

12. The system of claim 11 further comprising a logic unit for determining advantages of the second test methodology over the first test methodology.

13. The system of claim 11, wherein a survey mechanism is utilized to determine whether the selected subset of the target system's properties is covered by the first test methodology.

14. The system of claim 12, wherein the first test methodology is updated based on the second test methodology, in response to determining the advantages of the second test methodology.

15. The system of claim 12, wherein the first test methodology is replaced with the second test methodology, in response to determining the advantages of the second test methodology.

16. A computer program product comprising a non-transitory computer readable data storage medium having a computer readable program, wherein the computer readable program when executed on a computer causes the computer to:
construct a model to test the functionality of a target system, wherein a first test methodology has been used to test the target system, and the model is proposed to test the target system based on a second test methodology;
select a subset of the target system's properties covered by the model according to the second test methodology; and
determine whether the selected subset of the target system's properties as covered by the second test methodology is covered by the first test methodology.

17. The computer program product of claim 16, wherein advantages of the second test methodology over the first test methodology are determined.

18. The computer program product of claim 16, wherein a survey mechanism is utilized to determine whether the selected subset of the target system's properties is covered by the first test methodology.

19. The computer program product of claim 17, wherein the first test methodology is updated based on the second test methodology, in response to determining the advantages of the second test methodology.

20. The computer program product of claim 17, wherein the first test methodology is replaced with the second test methodology, in response to determining the advantages of the second test methodology.
